(19) United States
(12) Patent Application Publication
(10) Pub. No.: US 2026/0370898 A1
(43) Pub. Date: Nov. 19, 2026

(54) METHOD FOR NEURAL-HYBRID VIDEO STREAMING AND DISTRIBUTED TRANSCODING

(71) Applicant: BAYLOR UNIVERSITY, Waco, TX (US)

(72) Inventors: Andrew C. Freeman, Waco, TX (US); Samir Afzal, Waco, TX (US); Greg Speegle, Waco, TX (US)

(73) Assignee: BAYLOR UNIVERSITY, Waco, TX (US)

(21) Appl. No.: 19/678,995

(22) Filed: May 15, 2026

Related U.S. Application Data
(60) Provisional application No. 63/807,202, filed on May 16, 2025.

(51) Int. Cl. H04N 21/2662; H04N 19/40; H04N 21/239; H04N 21/442

(52) U.S. Cl. CPC H04N 21/2662; H04N 19/40; H04N 21/2393; H04N 21/44209

(57) ABSTRACT

A system for video streaming, the system comprising a video encoder that encodes a source video into at least one stream representation having a group of pictures (GOP) size, wherein the video encoder is further configured to (a) encode inter-coded P-frames using the GOP size and (b) at regular intervals within the GOP, separately generate intra-coded I-frames corresponding to a respective inter-coded frame at the same index in the stream representation. A stream packager receives the stream representation from the video encoder and produces for each of a plurality of quality levels of the source video at least (a) a baseline stream representation that includes I-frames and (b) a stable stream representation that includes alternate P-frame representations in place of the I-frames. A server stores the baseline stream representation and the stable stream representation and to serve segments thereof to one or more streaming clients via a network.

### RELATED APPLICATIONS

This application claims benefit of and priority to U.S. Provisional Patent Application No. 63/807,202, filed May 16, 2025, which is hereby incorporated by reference for all purposes as if set forth herein in its entirety.

### TECHNICAL FIELD

The present disclosure relates generally to video data, and more specifically to systems and method for a neural-hybrid video streaming and distributed transcoding.

### BACKGROUND OF THE INVENTION

Streaming video data is bandwidth intensive, despite extensive attempts to reduce the bandwidth requirements.

### SUMMARY OF THE INVENTION

A system for video streaming is disclosed that includes a video encoder that encodes a source video into at least one stream representation having a GOP size, wherein the video encoder is further configured to encode inter-coded P-frames using the GOP size and, at regular intervals within the GOP, separately generate intra-coded I-frames corresponding to a respective inter-coded frame at the same index in the stream representation. A stream packager receives the stream representation from the video encoder and produces for each of a plurality of quality levels of the source video at least a baseline stream representation that includes I-frames and a stable stream representation that includes alternate P-frame representations in place of the I-frames. A server stores the baseline stream representation and the stable stream representation and to serve segments thereof to one or more streaming clients via a network.

Other systems, methods, features, and advantages of the present disclosure can be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings can be to scale, but emphasis is placed upon clearly illustrating the principles of the present disclosure. Moreover, in the drawings, like reference numerals designate corresponding parts throughout the several views, and in which:

FIG. 1 is a diagram showing the influence of GOP size on bitrate, in accordance with an example embodiment of the present disclosure;

FIG. 2 is a diagram showing encoding processes to support frame injection, in accordance with an example embodiment of the present disclosure;

FIG. 3 is a diagram of a streaming format for MoQ transport, in accordance with an example embodiment of the present disclosure;

FIG. 4 is a diagram of a system for a QUIC Neural-hybrid Streaming (QNS) system, in accordance with an example embodiment of the present disclosure;

FIG. 5 is a diagram of a system for an NE codec, in accordance with an example embodiment of the present disclosure;

FIG. 6 is a diagram of a system for an NH encoding pipeline, in accordance with an example embodiment of the present disclosure; and

FIG. 7 is a diagram of a system for receiver-driven transcode, content analysis, and filtering, in accordance with an example embodiment of the present disclosure.

### DETAILED DESCRIPTION OF THE INVENTION

In the description that follows, like parts are marked throughout the specification and drawings with the same reference numerals. The drawing figures can be to scale and certain components can be shown in generalized or schematic form and identified by commercial designations in the interest of clarity and conciseness.

The present disclosure is directed to novel video streaming techniques that reduce the energy and networking burden for video publishers and clients. Current systems are designed for stateless video streaming. By not tuning the streamed representations for individual receivers, substantial bandwidth is wasted. For example, regular GOPs contain redundant intra-coded frames (I-frames). Significant optimizations for these systems can be obtained by precomputing various adaptation sets for each stream representation. The present disclosure dramatically reduces streaming costs, energy consumption, and barriers to accessibility for end users.

The present disclosure provides adaptive streaming mechanisms with receiver-driven GOPs for both new content and existing video on demand (VOD) libraries, by modifying a standard video encoder to separately generate low-rate I-frames alongside a large GOP stream of P- and B-frames. A P-frame has a single reference frame occurring earlier in the display order (also known as the picture order count or POC). A B-frame has two or more reference frames, both preceding and proceeding it in the POC. For existing VOD libraries, the encoder is invoked during a single-pass decoder stage to generate P-frame replacements for existing I-frames.

Individualized stream adaptation for current platforms is obtained by modifying Dynamic Adaptive Streaming over HTTP (DASH) client to support stream splicing with standard HTTP mechanisms. Novel mechanisms for distributing transcode tasks to end devices with customized encoders and WebAssembly are disclosed.

Next-Generation Streaming Systems are enhanced with Media Over QUIC (MoQ), to facilitate video streaming with the in-progress MoQ draft protocol. The present disclosure thus provides a novel streaming format.

Video streaming accounted for approximately 70% of all downstream Internet traffic in 2024. The present disclosure builds upon the latest developments in adaptive video streaming, while questioning commonly held assumptions about compression, distribution, and networking. When deployed in real-world streaming systems, the present disclosure can achieve a reduction in overall video bandwidth usage by 10-30% while serving clients with the same level of quality. This innovation corresponds to data cost savings for everyday customers, reduced energy usage, and increased wireless spectrum availability. The present disclosure can be generalized to benefit other prediction-residual streaming systems, such as audio, closed-circuit surveillance, 360-degree video, and virtual reality geometry.

VOD streaming systems waste enormous amounts of money and energy each year by transmitting temporally redundant data. The current systems typically leverage DASH or HTTP Live Streaming (HLS). Temporal segments of a video are encoded at various quality levels and stored as individual files on an HTTP server. A client then requests the needed time and quality segments. Significant research has focused on the Adaptive Bitrate (ABR) methods for the client to choose the quality level. However, these schemes do not take full advantage of long-term connection stability. Specifically, I-frames are transmitted at regular intervals to all receivers, resetting the decoder contexts even if the chosen bitrate level has not changed. This redundant transmission wastes 10-30% of the connection bandwidth, therefore wasting energy across each of the network nodes of the system.

The present disclosure can be used to develop new standards for receiver-driven rate adaptation that are more efficient and performant. Specifically, a VOD streaming format is disclosed that simultaneously provides both I-frame and P-frame references at the beginning of a video segment. An increase in the GOP size in an encoded video typically lowers the bitrate. The present disclosure provides a receiver with a stable connection to request the inter-coded video segments at a certain quality level, reducing the overall bitrate with an effectively increasing GOP size. For certain applications such as surveillance video, the present disclosure can outperform standard codec compression ratios despite using simpler compression techniques.

For large-scale video streaming systems, the present disclosure provides the following advantages. An adaptive streaming mechanism with receiver-driven GOP for both new content and existing VOD libraries is provided. Standard video encoders can be modified to separately generate low-rate I-frames alongside a large GOP stream of B- and P-frames. For existing VOD libraries, these encoders can be invoked during a single-pass decoder stage to generate P-frame replacements for existing I-frames. The present disclosure also builds upon the DASH standard to support receiver-driven stream splicing and stability-based adaptation. A DASH client can be modified to support stream splicing with standard HTTP mechanisms. New stream adaptation algorithms are disclosed that perform such stream splicing based on long-term connection stability. Next-generation streaming systems with MoQ are also disclosed.

The present disclosure provides novel features to standard video codecs and streaming systems, leveraging the ubiquity of high-speed and stable Internet connections now available. The potential cumulative impact on everyday users is immense, especially for those users with pay-per-usage Internet contracts (e.g., cellular data plans). By receiving less data, consumers can save millions of dollars per year while enjoying the same visual quality and lower latency. Alternatively, users can choose to receive higher-quality streams at prior bitrate levels. Content delivery networks (CDNs) and consumer client devices can see a dramatic reduction in energy consumption.

The present disclosure extends video compression and representation, implements the MoQ standardization process, provides receiver-driven adaptation strategies, and improves user immersion in virtual reality (VR) video streaming with user-specific stream adaptation.

Modern video streaming systems have a storied development history spanning the last three decades. Video codecs preceded streaming by several years. The H.261 standard was published in 1988, establishing many of the primary techniques still used today. These include macroblock structuring, chroma subsampling, motion compensation, and the discrete cosine transform (DCT). The H.264 standard was published in 2003, becoming ubiquitous through widespread hardware decoder implementation. H.264 solidified the GOP structure that is related to the present disclosure.

A GOP defines the distribution of I-frames and inter-coded frames. Intra-coded frames do not require the decoder to reference any other frames to produce an accurate image. In contrast, inter-coded frames encoded the differences between the current frame and one or more reference frames, generally resulting in greater compression ratios. Inter-coded frames can be designated as either P-frames or B-frames. B-frames interpolate the motion between these reference frames for more accurate prediction and even greater compression ratios than P-frames, at the cost of greater computational complexity. Each GOP can begin with an I-frame. A typical GOP structure follows the pattern IBBPBBPBB . . . , where there are two B-frames between each pair of I- and P-frame reference images. B-frames can optionally serve as reference frames themselves, although this further increases complexity.

Typically, the I-frame in a GOP is an instantaneous decoder refresh (IDR) frame. IDR frames direct the encoder to reset its compression contexts and clear the decoded frame buffer before decoding the GOP. These “closed” GOPs enable accurate video scrubbing. That is, a viewer can jump to any point in a video file, and the decoder can begin decoding at the nearest preceding IDR frame. Alternatively, “open” GOPs use non-IDR I-frames, also known as Clean Random Access (CPA) frames. A CRA frame permits inter-coded frames in the previous GOP to reference it. The decoder can begin decoding the I-frame of the next GOP to finish decoding the B-frames of the current GOP. Therefore, a CRA frame does not reset the decoder state. CPA frames unlock higher compression efficiency but can add complexity during scrubbing.

Modern video streaming systems operate on the concept of ABR switching. In the ABR paradigm, the server encodes the source video at various quality levels, producing distinct, independent streams. The client receives one stream at a time but can switch to a different stream if network conditions change. The conventional wisdom dictates that these streams should be encoded with closed GOPs, so that every GOP represents a point where the client can switch streams. AWS, for example, suggests that the GOP size should correspond to a new GOP occurring every 1-2 seconds (1-2X the video frame rate). This minimizes the latency to switch streams during any point in the video playback. A major goal of streaming platforms is to maximize the user quality of experience (QoE) while minimizing the video delivery cost. To this end, there has been substantial research into ABR algorithms. Common examples include throughput-based adaptation, the Buffer Occupancy based Lyapunov Algorithm (BOLA), and model predictive control (MPC).

Common HTTP Adaptive Streaming (HAS) systems such as DASH and HLS are stateless, meaning that the server does not track the current state of any client. Instead, the server simply holds several versions of the same video encoded with different bitrate target. Several times per minute, the client requests discrete segments of a video at the bitrate level chosen by the ABR algorithm. As noted above, each segment is typically a closed GOP. A major disadvantage to this stateless system is that the encoded streams cannot be customized or tuned for any individual client. Any client receiving a certain video segment at a given bitrate level can have the same visual quality and bandwidth usage, regardless of how long the client has been receiving that stream.

MoQ leverages the modern QUIC transport protocol for improved security, congestion control, and latency. Effort is underway to define a general-purpose video streaming format for MoQ, where each compressed video frame maps to an MoQ “object”. Open-source implementations of MoQ Transport are in active development. MoQ operates on a “publisher/subscriber” model. A video server can publish stream data for different-quality representations across several “tracks.” A client subscribes to the track(s) desired for its bandwidth and latency requirements. Each track maps to a single QUIC stream on the server-client connection, enabling lower latency than HAS and faster stream switching. A subscription can have a delivery timeout that determines the maximum latency between an object being published and when it is sent to the subscriber.

Due to the ubiquity of HAS today, little work has explored the notion of making these video servers behave in a more stateful manner. One exception is the AGiLE system, which proposes “pseudo-GOPs,” which provide additional starting points within a GOP (other than the beginning IDR I-frame). It achieves this by modifying the HEVC video encoder to generate a separate I-frame for each P-frame in the video. It is focused on minimizing the latency for new viewers to join a live stream. When a client joins the video stream for the first time, the current stream position can be in the middle of a GOP. Rather than requesting the segment from the beginning of the GOP, which could put the viewer further behind the stream position, the client can request the nearest intermediate I-frame of the pseudo-GOP. Past this point, segment requests and ABR proceed as normal.

AGiLE yields an overall 3.54% reduction in Bjontegaard Delta rate (BD-rate), meaning that it can reduce the bitrate usage by 3.54% while maintaining the same visual quality. For this evaluation, their method compares AGiLE with a 10-second GOP and 2-second pseudo-GOPS to a baseline video with 2-second GOPs. Temporal motion vector prediction (TMVP) can be disabled at the encoder, but the results still outperform the baseline method with TMVP enabled by more than 3%. A variant of AGiLE dynamically switches the encoder between 10-second and 2-second GOP sizes, but this variant yields little additional improvement. They further note that GOP sizes should be kept relatively consistent, presumably for compatibility with ABR mechanisms, though ABR was not evaluated as a component of the AGiLE evaluation.

The present disclosure notes that decreasing the frequency of I-frames generally decreases the bitrate, unless there is significant motion or scene changes, and that P-frames can be replaced with non-IDR I-frames in the raw bitstream with little impact on visual quality.

The High Efficiency Streaming Protocol (HESP) can be used to support dynamic I-frame requests based on both stream switching and packet loss. HESP defines a “normal stream” (NS) and a “companion stream” (CS). The NS is encoded with a large GOP size, while the CS has intermittent I-frames, similar to known pseudo-GOP structures. When joining a new stream, the client can request one I-frame from the CS, then request the remaining frames from the NS. If the connection is stable, the client can simply continue to receive the NS representation, seeing bandwidth savings from the large GOP size. If the client experiences packet loss, it can again request an I-frame from the CS, so that it can continue receiving from the NS without significant delay. Optionally, the CS can provide “reference repair pictures” (RRPs) that describe the differences between the last I-frame of the NS and certain P-frames in the NS. During recovery from packet loss, RRPs were shown to require up to 10 times less data transmission than I-frames, at the cost of greater encoder complexity.

HESP was available as a protocol draft with IETF from 2021 until late 2024, when it was archived. The protocol now requires a license agreement for access, and there are no open-source reference implementations available. Deployments of HESP are largely focused on low-latency livestreaming, as an alternative to WebRTC. In the present disclosure, frame injection is integrated with the widely deployed DASH protocol.

The VOXEL system can be used to optimize frame drops during periods of network congestion. Specifically, it can reorder the NAL units of the video stream to place B-frames at the end of a received segment. It can then modify the DASH protocol to operate over a semi-reliable QUIC transport stream (rather than TCP). When a client experiences packet loss, then, this loss is predominantly in the B-frames. The player can then still display the received P-frames at the beginning of the received byte range, offering users a lower frame rate representation rather than buffering or stuttering.

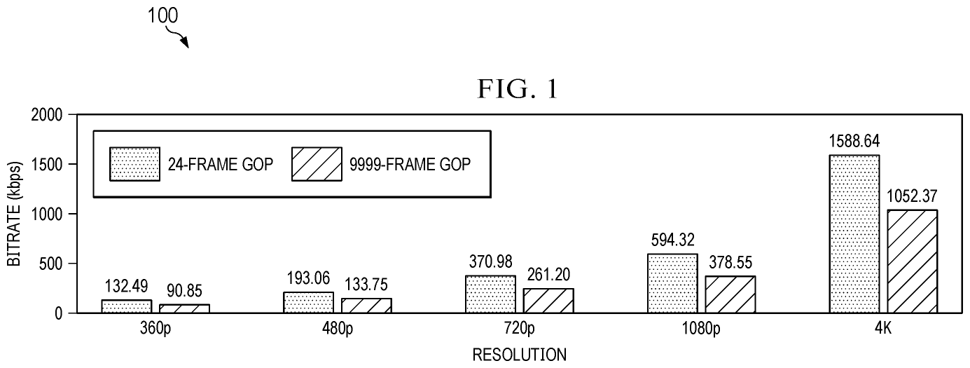

FIG. 1 is a diagram 100 showing the influence of GOP size on bitrate, in accordance with an example embodiment of the present disclosure. By using a very large GOP size, we see bitrate savings of approximately 30-36%, depending on the resolution.

To evaluate the potential impact of an I-frame replacement scheme, the bitrate change between small and very-large GOP sizes was evaluated. The Big Buck Bunny (BBB) test video sequence, an open-source animated film commonly used to evaluate video encoding and streaming techniques, was encoded at various resolutions. For each resolution level, the source video was transcoded with ffmpeg and x265 (for HEVC coding). Two transcoded versions at each resolution were produced: one with a 24-frame (1-second) GOP size, and the other with a GOP size of 9999 frames. A constant quality parameter (QP) equal to 23 was used, and the encoder was instructed to insert up to two consecutive B-frames between each P- or I-frame (matching the standard IBBPBBP frame pattern). The results are shown in diagram 100. At every resolution tested, a larger GOP representation yielded a 30-36% reduction in bitrate over a standard 1-second GOP size.

Secondly, it was verified that I-frames can be injected in place of P-frames with no significant reduction in quality. The AGiLE and HESP methods use specially modified encoders that are closed source. To verify the technique, two HEVC streams were spliced at a single frame injection; additional injections were not possible without encoder modifications, since the differing POCs caused decoder errors. The development of several open-source encoder modifications with support for frame injection is disclosed.

Originally, the justification for regular I-frames centered on the ability to scrub through a video. The I-frame of the GOP provides a reset state for the decoder, where it does not require any knowledge of prior GOPs. Although these conventions are necessary for local playback, they introduce needless redundancy in the context of modern HTTP-based video streaming. Novel video encoding and streaming techniques are disclosed that can transparently reduce the bandwidth requirement for receivers with a stable connection, with little-to-no impact on visual quality. The present disclosure maximizes the opportunity for real-world impact. Specifically, the disclosed systems and methods can allow modifications to the video encoders, stream packagers, and streaming clients. By utilizing novel receiver-side encoding, the disclosed systems and methods support retroactive implementation with existing VOD libraries.

The encoders are invoked on dedicated transcode servers. Although some video content can be processed with hardware encoders, software-based encoding is preferable to achieve the highest quality. In these cases, the modified software encoders can be deployed with little additional effort from video hosts. In the case of browser-based playback, the streaming client code can be transmitted to the receiver when the web page initially loads. A DASH system, for example, can send the dash.js JavaScript file. This client program can be modified to support the disclosed alternate I-frame scheme and stability-based adaptation. Importantly, the present disclosure requires no modifications to the underlying video decoders, which are often hardware-accelerated, which means that the system can utilize server-side encoder deployments to have immediate utility on billions of user devices worldwide.

The present disclosure can be utilized with other prediction-residual streaming systems, such as audio, closed-circuit surveillance, 360-degree video, virtual reality geometry and pseudo-stateful data streaming. It provides many of the bandwidth benefits of fully stateful systems, while outperforming them in energy usage, cost, and practicality.

Standard video encoders reset the compression context at regular intervals. The I-frame encoded at the beginning of a GOP is typically much less compressible than a P-frame. The present disclosure modifies common video encoders to support post-facto GOP decisions. After encoding an I-frame for a given GOP, a P-frame is computed and separately encoded that is lossless relative to the I-frame. A receiver can have nearly identical video quality if receiving the I-frame or starting P-frame for this segment. The system can be used to generate alternate P-frames for existing VOD archives through an integrated single pass of a decoder.

The present disclosure can be implemented by directly modifying open-source implementations of codec standards, such as the CPU-based codecs distributed with FFmpeg or in other suitable manners. In one example embodiment, pseudo-GOP encoding with HEVC (H.265) can be used, which has both high compression efficiency and widespread hardware adoption. The remaining codecs can be extremely similar. After explaining pseudo-GOP encoding strategies for HEVC, the same application for the AVC (H.264), VP9, and AV1 codecs can be apparent.

For I-frame generation for new encodings, two subtasks can be used, (a) I-frame injection and (b) P-frame injection.

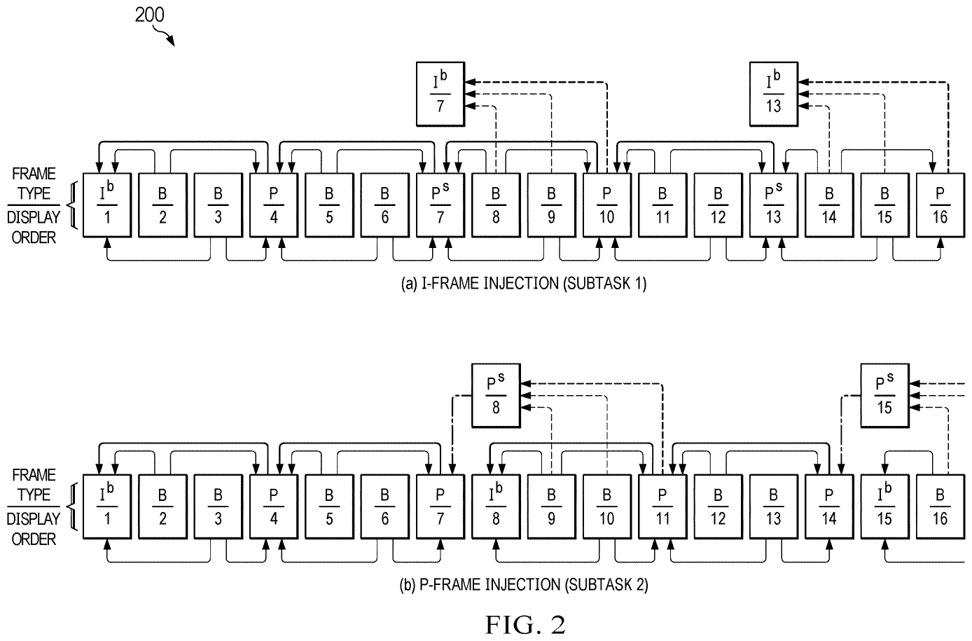

FIG. 2 is a diagram 200 showing encoding processes to support frame injection, in accordance with an example embodiment of the present disclosure. “I^{b}” indicates an I-frame, as part of the Baseline stream. “P^{s}” indicates a P-frame, as part of the Stable stream. The arrows indicate the frame(s) that a given frame references for decoding.

For I-frame generation, a source video being transcoded for the first time can take the form of a video stream encoded with majority inter-coded frames, using an “infinite” GOP size. That is, the stream can have a single IDR I-frame at the beginning, and P- and B-frames following that where suitable. At regular intervals, the encoder context models are duplicated and a CRA I-frame is separately encoded. These frames can be CRA so that the Picture Order Count (POC) is not reset. That is, if a client receives the CRA frame, it cannot break the decoder's interpretation of later inter-coded frames from the baseline video.

For HEVC, the x265 encoder is modified. Currently, x265 allows one to specify the keyint and min-keyint, which specify the maximum and minimum GOP size, respectively. Specifically, these arguments control the frequency of IDR I-frames. The library does provide direct control of the CRA I-frame frequency. For the present disclosure, a command line argument, cra-int is added, which can directly specify the interval of dedicated CRA I-frames. Each CRA I-frame can be stored as supplemental enhancement information (SEI) in the inter-coded frame occurring at the same index. This can make the output files amenable to stream packaging.

For P-frame generation for existing encodings, the more difficult task is modifying existing VOD streams to add pseudo-GOP support. The inverse approach can be used to generate P-frames where a stream currently has IDR I-frames. Whereas the above method can serve a new client with only one modified frame (the beginning I-frame) where suitable, this method can consistently serve the client with alternate P-frames. This method can function through the precise coordination of both a decoder and encoder. When the libav HEVC decoder reaches the frame preceding an IDR I-frame, the context models can be copied into an instance of the modified encoder and the decompressed I-frame can be provided to the encoder, instructing it to generate a P-frame.

In this example embodiment, the P-frames are lossless relative to the I-frames that are being replaced. Otherwise, a client that decodes the P-frame representation can experience significant quality drift over time. When a merged representation with the I-frames removed is constructed, it can additionally be ensured that the POC is still valid and correct. This can preclude the use of “open” GOPs, which allow B-frames to reference frames in the next GOP. That is, if a B-frame originally references the I-frame at the beginning of the next GOP, but that frame is replaced with a P-frame, the circular references can produce an invalid decoder state. However, we can safely avoid this issue. When encoding a video for online streaming, it is widely accepted that videos should be encoded with closed GOPs, to better support dynamic stream switching.

For edge-distributed partial transcoding, there is a unique opportunity to leverage edge computing resources in the pseudo-GOP encoding setup. If an existing VOD platform were to incorporate the disclosed pseudo-GOP streaming pipeline for existing encodings, substantial time and compute resources would be required to reprocess every video managed by the platform. The library owner could prioritize these operations based on video popularity, but such a strategy can be difficult to scale. Instead, a purely request-based system with edge computation can be used. When a real user requests a particular video segment, the alternate P-frame computation is offloaded to that client. For browser-based clients, the modified video encoder to be invoked can be sent as WebAssembly or JavaScript encoder API directives. Since the client can encode a single frame for each segment, this process should not cause notable slowdowns on the user's device. The encoded frame can be pushed to a separate server endpoint with a simple HTTP POST request. This endpoint can sanitize the POSTed data for security before inserting it as SEI data in the original video file.

The efficacy of the encoding strategies can be evaluated on a realistic array of video subjects, resolutions, and quality levels by continually testing against the open-source BBB video sequence. For final validation, a subset of the YouTube User-Generated Content (UGC) dataset can be used. For each encoder, each video can be re-encoded at various constant bitrate levels.

The UGC videos should be encoded with TMVP disabled, and then encoded at various bitrates and resolutions with an “infinite” GOP size and alternate I-frames generated at regular intervals (determined by the GOP size of the original video from the dataset). A merged copy of each encoding can then be created, where some P-frames are randomly replaced with their associated I-frames obtained from the SEI headers. This merge process can emulate the effect of stream switching on the actual video bitrate, although one quality level at a time can be examined for this stage of the evaluation. These merged encodings can be compared to the originals from the dataset and used to evaluate the effect of the encoding scheme on the bitrate and perceptual quality, using standard metrics such as peak signal to noise ratio (PSNR), structural similarity index measure (SSIM), and the Video Multimethod Assessment Fusion (VMAF).

A similar approach to evaluate the P-frames and associated metadata for the existing videos. The merged video representation can replace every I-frame from the baseline videos with the generated P-frames. The evaluation metrics can be the same as previously discussed. On a cloud service, software for edge-distributed transcoding can be deployed. The cost for the server to distribute the P-frame encoding to end-user devices can be measured and compared to the cost of performing the encoding server-side. For this evaluation, a variety of consumer-grade devices can be used, including standard laptops, desktops, and smartphones.

Open-source implementations of the modified HEVC, AVC, VP9, and AV1 software codecs can be produced, as well as an open-source command line toolset for producing specialized video representations, similar to FFmpeg. This functionality can be integrated directly into a fork of FFmpeg.

Although the HESP protocol offers limited support for frame injection, its proprietary nature and livestream focus inhibit its accessibility for existing systems. Meanwhile, the open standard DASH protocol is widely deployed, but it does not currently support stream individualization mechanisms such as frame injection.

Open-source DASH software can be modified to support the disclosed pseudo-GOP encoding schemes, evaluating the real-world impact on bandwidth and QoE. To evaluate adaptive streaming systems, realistic network behavior can be simulated. For this effort, a streaming testbed can be built using three bare-metal Linux machines. Of the machines, one can be designated the server, one the client, and one a router. Standard Linux tools can be used, such as tc and tcpreplay to simulate various network conditions and replay real-world network trace files. This testbed can be used to exhibit interactive demonstrations of adaptive video streaming.

To provide stream packaging for DASH, HLS or other suitable protocols, a pipeline can be established for packaging pseudo-GOP stream representations for the DASH protocol. To begin, a standard process for encoding several stream variants across the “bitrate ladder.” The open-source DASH stream packager known as Shaka can also be used. One starting point is an ISO Base Media File Format (BMFF) On Demand profile standard, which includes that each video representation (quality level) can be composed of a single MP4 file on the server. The time slices that a client can request (i.e., individual GOPs) are MP4 segments. Shaka packages the MP4 files according to user arguments, such that the segments of each representation are aligned to the same timestamps. It then generates a DASH Media Presentation Description (MPD) file. The client can retrieve the MPD file at the beginning of a streaming session.

The MPD file provides the URLs of the video representations and a sequence of SegmentBase elements, each conveying the corresponding start and end byte indices in the video file. When the client wants to load that segment of the video, it simply issues an HTTP GET request for the byte range. The data received constitutes a single GOP, which is decoded and displayed.

To support pseudo-GOP encodings, the Shaka packager requires minor modifications. For every input MP4 file, two representations are produced in the MPD. The first representation, a “Baseline” stream, can express the byte ranges needed to obtain standard GOPs with I-frames. The second representation, a “Stable” stream, can express the byte ranges needed to obtain our alternate GOP representation, without an I-frame. This design can allow a client, when switching quality levels, to receive at least one segment from the baseline stream before switching to the stable stream.

Shaka can also be modified to produce multiple representations of Baseline streams with varying numbers of inter-coded frames. These representations allow a client adaptation algorithm to select a stream with a lower bitrate and frame rate at a desired visual quality. Intra-coding can still occur in specific blocks or slices in inter-frames.

For stream adaptation and QoE maintenance, the open-source reference DASH client dash.js can be modified to receive the pseudo-GOP representations using an adaptation algorithm. The most common stream adaptation algorithms today, such as BOLA, are buffer based. They monitor the client-side video buffer as a proxy for the network congestion and stability. Simply put, if there is little data in the buffer, the client can switch to a lower-quality stream. If there is much data in the buffer, the client can switch to a higher-quality stream.

Pseudo-GOP streams differ from standard streams in that bandwidth is not fixed. For example, a standard encoder targeting 2-second GOPs can adjust the quality parameter for each frame to keep the GOP near a target bitrate. Each GOP, then, can have approximately the same data size. In contrast, the first segment of a pseudo-GOP stream can be large, but remaining segments (from the Stable) stream can be much smaller. This breaks the fixed-bandwidth assumption of existing adaptation algorithms. With this factor in mind, an adaptation mechanism can be described as follows.

When a client begins streaming a video with the disclosed systems and methods, a default quality level is chosen and a request for the first segment from the Baseline stream is made. The second segment can be requested from the Stable stream. The client can remain on the Stable stream until the adaptation algorithm deems it necessary to switch quality levels. The client can then request the corresponding segment from the Baseline stream of the new quality level.

If the new stream is higher quality, the first Baseline segment can be significantly larger than the current Stable stream segments. As such, the client can experience a latency spike when receiving this segment. To avoid stalling, the disclosed algorithm can continue to request from the current Stable stream until it begins receiving segments from the higher-quality Stable stream. Once the new Stable stream has enough data, playback can fully switch to this stream. Modifications to the BOLA parameters can be used to ensure that the QoE remains high during quality switches. Furthermore, a variant of the adaptation algorithm that seeks to match the quality plot of the standard BOLA algorithm can be used.

Using the disclosed streaming testbed, various levels of network congestion and transmission delay can be simulated. Realistic conditions can be modelled by transmitting real-world network trace datasets. Within the simulated networks, the efficacy of DASH-based streaming solution with the generated pseudo-GOP datasets can be evaluated. Throughout the videos' durations, the effect of network congestion on the video bandwidth usage and QoE can be measured. Different encoding strategies can be compared with customized adaptation algorithms to a baseline representation with a fixed GOP size and standard adaptation algorithms (such as BOLA). The tests can be repeated for each of the modified encoders, and findings can be validated by replicating the streaming server on the cloud, using a real-world CDN service. User studies can also or alternatively be used to measure the subjective QoE of our streaming system, and user questions can ask about such factors as playback smoothness, perceived image quality, buffering, and quality switching.

To enhance next-generation streaming systems with MoQ, the following problems are addressed. Although the DASH and HLS protocols have made VOD streaming accessible to the masses, their relatively high latency makes them ill-suited for many livestreaming tasks, including web conferencing and game streaming. MoQ can be used to provide a next generation of streaming system with a single transport protocol for both VOD and livestreaming applications.

A novel streaming format is disclosed that leverages the pseudo-GOP encodings with the unique semantics of MoQ. By evaluating the resulting format in comparison to the DASH-based approach, both latency and BD-rate metrics can be improved. This novel adaptation strategy can drop inter-coded frames to optimize the bandwidth/quality tradeoff for individual receivers. For MoQ protocol draft contributions, amendments to the protocol draft are disclosed.

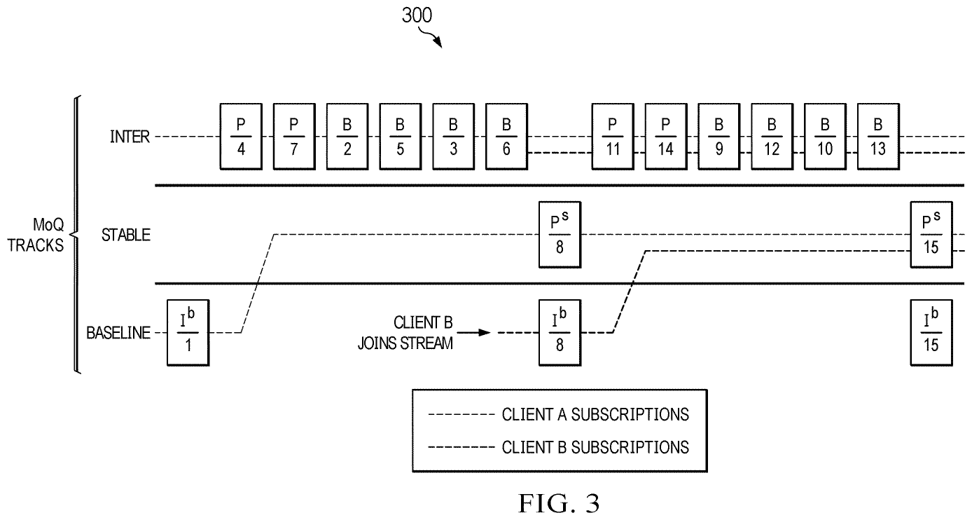

FIG. 3 is a diagram 300 of a streaming format for MoQ transport, in accordance with an example embodiment of the present disclosure. The client subscribes to two video tracks simultaneously. The Inter track delivers frames out of order, so that playback cannot be interrupted in the case of dropped packets.

A streaming format with frame injection and reordering is disclosed. The main components of this format are as follows. First, the format can support I-frame injection. Whereas the disclosed DASH integration includes packaging multiple MPD representations for frame injection, the various frame types can also or alternatively be split between different MoQ tracks. For example, FIG. 3 shows how streaming clients Can subscribe to a Baseline track until they have received their first I-frame, then switch their subscription to a Stable track to receive alternate P-frames. Meanwhile, a separate “Inter” track carries the P- and B-frames occurring in each pseudo-GOP. The client holds a constant subscription to this track.

Second, the Inter track can send encoded frames in a different order than they are displayed. P-frames can be transmitted first, followed by B-frames. We can set the priority of this track to be lower than the Baseline and Stable tracks, such that the Inter frames are more likely to be dropped during periods of congestion. By reordering the frames in this way, the client can still receive and decode P-frames during periods of data loss, thus mitigating the risk of playback buffering. Compared to the DASH customizations necessary for the VOXEL system, the disclosed novel approach leverages existing mechanisms in MoQ Transport.

For learning stability-based adaptation with frame dropping, an example learning-based adaptation algorithm is disclosed for a streaming format, where the key goal is to optimize the bandwidth usage for cost and energy targets. Dropping frames in order to maintain a target latency can be selected, or dropping frames based on a user's tolerance can be selected. In this case, the adaptation algorithm can dynamically adjust the delivery timeout for the Inter subscription to determine how many B-frames can be dropped for each pseudo-GOP. Across multiple streaming sessions, a machine-learning model can learn to predict the user's tolerance to frame drops. Key indicators can be stream watch duration and manual quality overrides. With this user-specific adaptation system, the bandwidth and energy necessary for any users to enjoy their maximum QoE can be minimized.

The present disclosure can reduce overall video bandwidth usage by 10-30% with no significant impact on visual quality, thereby saving everyday users millions of dollars in bandwidth fees each year. Notably, the disclosed systems and methods require no changes to hardware-accelerated decoders. Therefore, end users can see an immediate reduction in bandwidth usage on their existing devices. Finally, a large-scale reduction in video-related bandwidth usage can reduce the burden on global networks and free up space on the wireless spectrum. Therefore, even users engaged in non-video data transmission can see a noticeable increase in transmission speed.

Beyond its applications for online entertainment, live video streaming has become a crucial component of modern science. For example, ecologists can use remote sensors to monitor wildlife behavior, experts can deliver educational seminars to viewers around the world, biologists can collaborate remotely on microscopy and biomedical imaging tasks, and everyday citizens can engage in data collection for large-scale studies (e.g., pollution and weather monitoring). However, as live streaming grows, it has brought significant challenges for bandwidth usage, resource utilization, and real-time moderation. These challenges can be effectively addressed through fundamental research into a neural-hybrid video streaming system.

QUIC Neural-hybrid Streaming (QNS) provides a compression and streaming system with hybrid frames using neural-enhanced methods. QNS addresses issues of efficiency, latency, and content safety to fulfill the promises of high-quality, low-bandwidth media delivery that traditional streaming technologies have failed to deliver so far.

The disclosed systems and processes address the lack of scalable neural-enhanced compression methods. Modern neural-enhanced video compression methods, such as Neural Video Compression (NVC) and Gaussian splatting (GS), yield state-of-the-art compression ratios compared to traditional codecs. However, their slow performance and high compute requirements make them impractical for usage in everyday streaming systems. Furthermore, their unique compression artifacts can yield poor visual quality at high loss rates. Overcoming this barrier requires integrating these methods with traditional codecs using a hybrid representation, optimizing them for high speed, and evaluating their impact on perceptual quality under variable bitrate conditions.

Bandwidth inefficiency in segment-based streaming is also addressed. Current live video streaming systems consume excessive bandwidth due to rigid frame structures and coarse-grained ABR protocols. The existing designs exhibit redundant transmission even under stable network conditions. This wastes significant bandwidth and limits scalability. Overcoming this barrier requires a flexible hybrid representation that minimizes the bandwidth requirements when network conditions are stable.

The present disclosure also addresses inefficient resource utilization in centralized video processing. Existing video streaming pipelines rely heavily on data center-based transcoding and centralized moderation services, which creates challenges for scalability, resiliency, and latency. Transcoding is typically concentrated in server infrastructure, which limits opportunities to offload processing to heterogeneous edge devices that could share computational load and reduce latency. Meanwhile, real-time moderation, including content classification and policy enforcement to detect harmful or illegal content, is often delayed or degraded because massive data streams must be processed centrally before action can be taken. Addressing this barrier requires new strategies that enable distributed transcoding pipelines and decentralized moderation workflows, allowing each to operate efficiently and closer to end users.

The present disclosure improves the scalability of Neural Enhanced (NE) image codecs with a unified framework that aligns NE representations with traditional coding, with an emphasis on preserving perceptual fidelity, maintaining cross-frame temporal consistency, and achieving efficient real-time deployment on resource-constrained embedded platforms. The bandwidth requirements for live video streaming are also reduced using hybrid representations (with optional NE frames), novel adaptation algorithms, and QUIC congestion control enhancements to minimize redundant data transmission. Minimized server-side resource utilization for live video workflows is accomplished using dynamic video workflow distribution strategies for transcoding and content analysis across edge consumer devices, leveraging compute resources more effectively and unlocking new user-specific moderation capabilities.

The disclosed systems and processes reduce live stream bandwidth usage by 10-30%, reduce data transmission costs for video providers and consumers, and increase content safety and accessibility. Neural-hybrid video streaming is provided by structuring neural-enhanced keyframes and adapting hybrid representations to network dynamics to maintain playback stability, even in distributed systems operating under high latency and failure variability. By closing key gaps that currently prevent neural codecs from practical deployment, QNS provides a realistic pathway to improve end-to-end neural media delivery, extended reality (XR), scientific observation and collaboration, and other interactive real-time applications.

The broader impacts of this work will contribute to the mission of NSF by reducing global network loads, democratizing access to high-quality video information, enabling advanced scientific observation and collaboration efforts, accelerating the development of modern streaming protocol standards, and increasing the safety and accessibility of live video streaming for everyday users.

NE such as neural image compression (NIC) models and GS representations are used to support high speed encoding and predictable rate-distortion tradeoffs. Hybrid neural and traditional frame representations are adapted to network dynamics, enabling bandwidth savings while preserving smooth playback and user-perceived quality. QUIC congestion control algorithms and packet scheduling are adapted to support neural-hybrid streams. Transport-layer decisions (such as pacing and frame prioritization) interact with playback behavior, and strategies to mitigate playback issues during network congestion are provided.

Distributed workflow strategies for distributing video transcoding and analysis tasks across heterogeneous edge devices are also provided. Tasks are assigned based on device capacity, network conditions, and content characteristics, and strategies to balance latency, reliability, and load across dynamic environments are provided.

For content-aware moderation on the edge, real-time content analysis can be integrated into live streaming using lightweight neural models running on edge devices. Safe and efficient content filtering can be performed even when device availability changes, or when network conditions fluctuate.

By introducing neural components alongside traditional codecs with mechanisms that adapt to network and device variability, the practical barriers that currently prevent high-compression neural codecs from being deployed at scale are eliminated. A transition path toward fully neural media delivery across video, XR, and other interactive real-time applications is provided. The disclosed systems and processes can be directly applied to existing scientific efforts that are burdened by high-rate video data, such as remote wildlife sensing, educational seminars, collaborative study of video microscopy data, and public data collection. The QNS system reduces the bandwidth requirements and latency of these deployments, while increasing the visual quality, thereby increasing the accuracy and accessibility of such studies.

Image codecs such as JPEG (1992) use foundational processing techniques to achieve high compression ratios. Video codecs extend these concepts to better compress the changes between consecutive image frames in a sequence. Video codecs in common use today include AVC/H.264 (2003), HEVC/H.265 (2013), AV1 (2018), and VVC/H.266 (2020). Newer codecs typically offer better compression at a given quality, but require more computational resources.

Traditional codecs typically leverage the Discrete Cosine Transform (DCT) in order to obtain coefficients for the spatial or temporal information. These coefficients are variably quantized, with higher quantization levels introducing more loss but greater compression. The goal of any codec is to form an accurate prediction of each source symbol. The prediction residuals are passed to an entropy coder, which can use fewer bits to encode data predicted with high accuracy. Video codecs can use motion compensation to form accurate prediction models for the changes between two images.

Video codecs employ a GOP structure that alternates between different encoded frame types. I-frames (intra-coded, also known as keyframes) are self-contained and can be decoded independently, providing random access points but lacking the efficiency of temporal context. Inter-coded frames achieve better compression by subtracting the motion of nearby reference frames. P-frames (predictive-coded) reference one previous frame, while B-frames (bi-predictive) interpolate between two or more past frames and future frames to achieve even higher compression at the cost of computational complexity. GOPs typically begin with an I-frame to reset the decoder state and maintain synchronization. However, frequent I-frames introduce overhead and limit compression efficiency. GOP structures require frequent I-frames, creating significant redundancy.

NE compression refers to compression methods such as learning-based (NIC and NVC), and optimization-based (GS). NIC methods seek to use machine learning to produce the compressed representation for an image. These methods generally fall into one of two categories: (i) autoencoders, such as VAE, learn a latent space for a set of images, and can effectively compress new images that are similar to the training distribution; (ii) overfitted codecs, such as Cool-chic, train a lightweight model for one particular image, encoding it within the model's weights.

NVC extends NIC methods to compress consecutive input images as a collective sequence. Early work such as DVC demonstrated competitive performance against H.264 but suffered from artifacts due to warping-based prediction. More recent approaches like DCVC introduced feature-space conditional coding, improving efficiency and robustness at low bitrates. The state-of-the-art DCVC-RT model further optimized this design for “real-time” usage, achieving compression comparable to Versatile Video Coding (VVC) while enabling 1080p coding on high-end GPUs. However, it cannot perform simultaneous transcode to multiple quality levels in real time.

For GS, recent work shows that high-quality visual content can be reconstructed from compact Gaussian primitives rather than implicit neural features. The GS optimization process iteratively adjusts Gaussians so that their rasterization will produce an image closely aligned to the input images. Most work in this area is focused on 3DGS for neural radiance fields. Splatting techniques have shown promise, however, for 2D representations. Image-GS introduced 2D colored Gaussians for image compression. GSVC further adapted the approach for video by preserving Gaussians between consecutive image frames, but allowing certain Gaussian parameters to evolve, to capture the motion changes. In general, GS methods enable very high compression at high quality levels; however, they are notoriously slow to optimize, making them unsuitable for real-time video encoding.

NE techniques achieve state-of the art compression performance, but their computational demands limit their practicality. Video streaming systems can meet the demands of low latency, adaptability, and efficient bandwidth use. Modern streaming relies on ABR switching, where servers encode multiple quality representations, and clients switch streams based on network conditions. To enable seamless switching, streams use small GOPs, typically every 1-2 seconds. This configuration minimizes latency but forces pre-computed, fixed representations. Protocols like DASH and HLS implement ABR over HTTP in a stateless manner, where clients request discrete segments at chosen bitrates. While simple and effective, this approach can have high latency and bandwidth.

MoQ leverages the modern QUIC transport protocol for improved security, congestion control, and latency. A video publisher can push stream data for different-quality representations across several “Tracks.” The Track data is then distributed across one or more relays. A client subscribes to a relay with the Track(s) desired for its bandwidth and latency requirements. Each Track maps to a multiplexed QUIC stream on the server-client connection, enabling lower latency than HTTP ABR and faster stream switching. However, ongoing MoQ work still assumes the use of closed-GOP representations.

Current streaming architectures depend on pre-computed, small-GOP representations, limiting adaptability and preventing integration of neural or on-the-fly compression methods. To reduce startup delay in live streaming, recent approaches inject additional I-frames within standard GOP structures to achieve hybrid coding.

“Pseudo-GOPs” can reduce join latency in live streaming by inserting additional I-frames within a GOP, by modifying the HEVC encoder to generate a separate I-frame for each P-frame, allowing new viewers to start decoding from the nearest intermediate I-frame rather than the GOP start. While AGiLE improves startup latency and achieves a 3.54% BD-rate reduction compared to short GOP baselines, it requires disabling temporal motion vector prediction (TMVP) and maintaining consistent GOP sizes for ABR compatibility. These constraints limit its applicability to broader streaming scenarios and do not address adaptive encoding or personalization.

The High Efficiency Streaming Protocol (HESP) provides frame injection through a dual-stream design. It defines a Normal Stream (NS) encoded with large GOPs to maximize bandwidth efficiency, alongside a Companion Stream (CS) that provides frequent I-frames for rapid recovery and stream switching. Clients request an I-frame from the CS when joining or recovering from packet loss, then resume NS playback for efficiency. While HESP reduces latency and improves resilience, its proprietary nature creates barriers for widespread adoption. Current frame injection approaches rely on rigid GOP structures, require invasive encoder modifications, and fail to support dynamic, stateful adaptation or integration with neural codecs. These limitations hinder scalability, personalization, and compatibility with next-generation streaming protocols.

Prior work has addressed distributed transcoding and content analysis as key enablers of scalable, low-latency, and safe video workflows. A video transcoding workflow converts original content into multiple formats or resolutions to support diverse devices and network conditions. Because transcoding and delivery require significant compute and bandwidth, recent research is shifting these tasks closer to the user. Edge-based transcoding offloads computation from centralized data centers to servers deployed physically close end users, improving responsiveness and lowering the volume of data moving across the network. Studies on workflow management for cloud-edge transcoding distribution have shown that efficient placement and scheduling can reduce costs and latency while improving overall resource utilization. End-user smartphones can participate in edge computing, by transcoding their received video streams and transmitting those representations to other devices via a peer-to-peer (P2P) network. While modern smartphones have the necessary hardware to support real-time transcoding, P2P video transcoding and delivery is considered impractical for real-time use due to the difficulty of coordinating unreliable edge devices, limited uplink bandwidth, and high system management overhead.

As live streaming grows, moderating content at scale has become increasingly challenging. Traditional VoD streaming enables offline content analysis before publication, ensuring compliance with platform policies (e.g., violence, drugs, sexual content), albeit at the cost of significant delay. The latency demands of live video make automated analysis impractical in many cases-often, human moderators are enlisted to perform manual content checks of popular streams. The unidirectional, pull-based paradigm of traditional video streaming protocols (e.g., DASH and HLS) is a limiting factor to this content moderation problem.

Specifically, all automated analysis must be performed server-side, increasing the latency for all downstream users and preventing the use of user-specific content policies. Server-side transcode and analysis workflows add undue latency and cannot accommodate user content preferences.

The present disclosure takes advantage of computational resources throughout the network by offloading transcoding and content analysis workflows to viewers' devices. New analysis applications can be added without increasing the server-side compute requirements, which enables highly granular and user-specific content filtering policies.

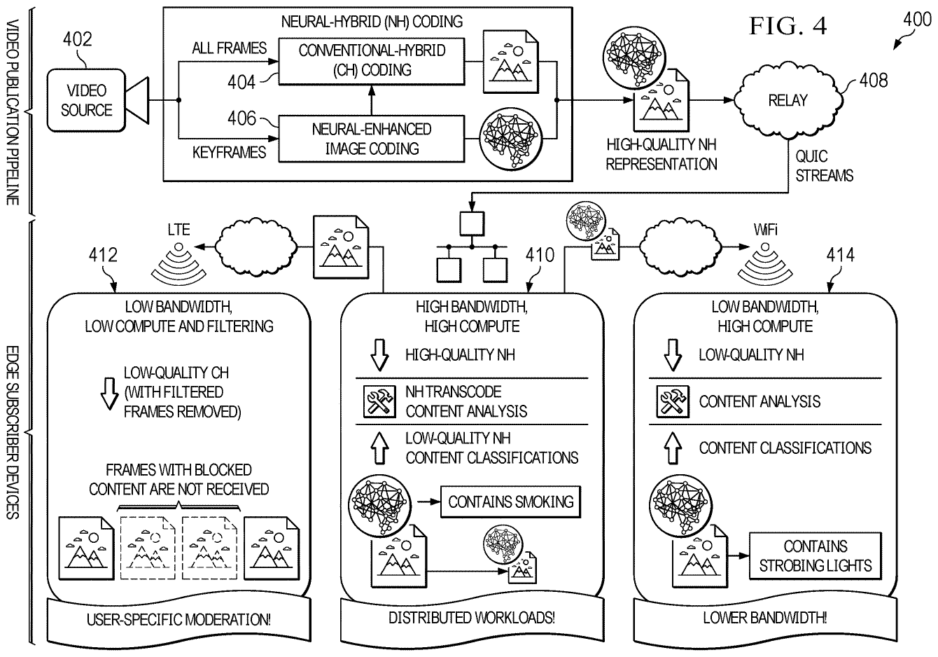

FIG. 4 is a diagram of system 400 for a QUIC Neural-hybrid Streaming (QNS) system, in accordance with an example embodiment of the present disclosure. System 400 can be used to integrate traditional video compression, neural-enhanced image compression, adaptive streaming, and distributed computation into a unified end-to-end system or for other suitable purposes.

The video publication pipeline includes video source 402 generating output to neural-enhanced image encoder 406 operating alongside conventional codec 404 to enable neural-hybrid streaming with on-demand keyframe delivery based on client requirements and network conditions. The encoded video is transmitted by relay 408 using the MoQ transport protocol. At the network edge, heterogeneous edge subscriber devices 410, 412 and 414 participate in distributed computation, performing tasks such as transcoding and content analysis for user-tunable moderation.

Devices 410 with high compute capabilities receive neural-hybrid representations, with a neural-enhanced I-frame at the stream join point (for less bandwidth). These devices can also perform client-side transcoding and content analysis. Lower-quality transcoded representations are made available for devices 412 and 414 with lower-bandwidth connections, which can receive a conventional-hybrid representation that uses a conventional I-frame at the stream join point, similar to HESP. QNS not only reduces server-side processing overhead but also enables scalable workflow distribution, representation-aware delivery, and user-specific content moderation.

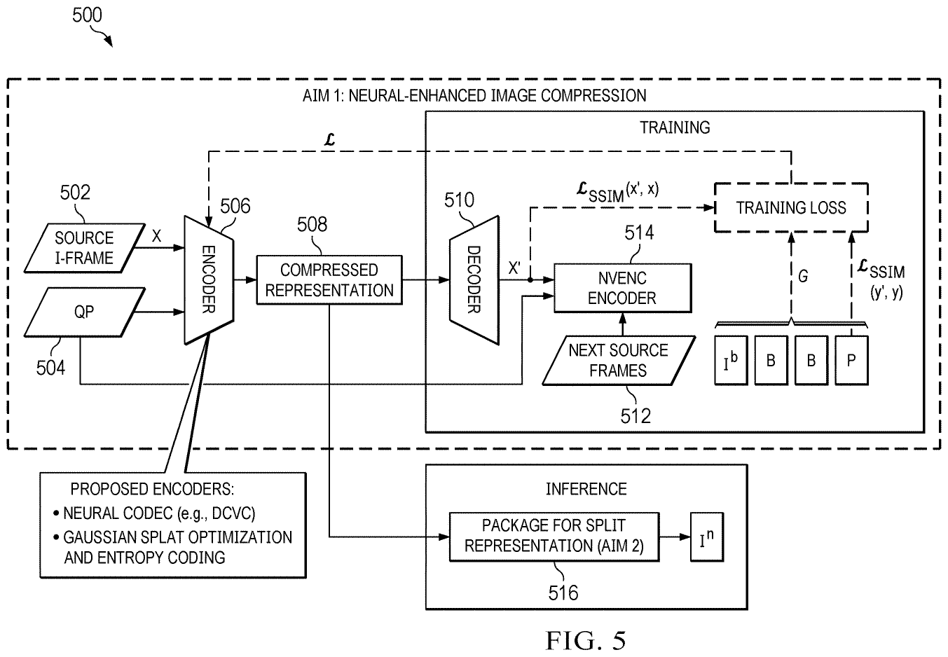

FIG. 5 is a diagram of a system 500 for an NE codec, in accordance with an example embodiment of the present disclosure. System 500 includes source I-frame 502, QP 504, encoder 506 compressor 508, decoder 510, next source P frame 512, NVENC encoder 514 and package 516, each of which can be implemented in hardware or a suitable combination of hardware and software.

State-of-the-art NE codecs provide strong compression performance, but are impractical for real-world deployment. The present disclosure brings NE image codecs into quality alignment with traditional intra-coding, and increases their scalability through fine-grained quality decisions, entropy coding, and speed acceleration.

System 500 augments NE image codecs with frame insertion loss. Rather than targeting the maximum compression ratio per se, system 500 generates NE I-frames that can later replace standard I-frames in the hybrid streaming pipeline, and minimizes the distortion of later inter-coded frames. System 500 can learn to preserve the most impactful visual properties of the standard codec. A state-of-the-art neural codec such as DCVC-RT, and optimization-based 2D Gaussian splatting technique are used. For training/optimization with both techniques, compute loss L by the following:

[symbol]

=w₁ [symbol] _{SSIM}(x′,x)+w₂ [symbol] _{SSIM}(y′,y)+w₃G,

where:
x 502 is the source I-frame
x′ is the neural-decoded frame
y 512 is the next source P-frame, and
y′ is the final decoded P-frame.

y′ can be generated by constructing a standard I-frame from x′ and using that as decoder 510 reference to reconstruct the next P-frame, as shown in system 500. G is the compressed size of the reconstructed GOP. The SSIM metric models the perceptual quality of a distorted image to its reference. Weights w₁, w₂ and w₃ can be optimized through hyperparameter tuning on VMAF quality metric, which is more accurate than SSIM but is not differentiable.

The intra-coding performance of the state-of-the-art DCVC-RT neural codec can be compared to the HEVC x265 codec, such as by encoding the first frame of each 4K video in the UVG dataset, then comparing the resulting VMAF visual quality and compressed bitrate. DCVC-RT can dramatically outperform HEVC with BD-rates in the range of ~31-50%, indicating very strong compression benefits. However, compression artifacts can be dramatically different between the two codecs. The neural codec can produce a smoother image, but this can result in lost detail in salient regions such as the face. To support transitions between NE and traditionally encoded content, the disclosed training/optimization scheme can minimize the differences between their compression artifacts.

To incorporate quality condition for training and optimization for video streaming, traditional encoders are set to output a constant bitrate (CBR) for each GOP. For this, encoder 506 dynamically adjusts the “QP” EN, [0,63] each frame. Existing NE image codecs, however, have only a coarse and nondeterministic range of quality levels. For the NIC model, the present disclosure incorporates QP 504 decision from the traditional encoder as an explicit condition in the model, so that it can learn to produce lower-quality embeddings at higher QP 504 choices. For repeated GS training runs, a large dataset can be created that conveys the input QP 504, image resolution, number of input Gaussians, the number of iterations, learning rate, opacity culling threshold, and output visual quality. An ML algorithm such as XGBoost or Random Forest can be trained to form accurate predictions on the optimal GS parameters for each QP 504 setting that will minimize the resulting bitrate. For both NIC and GS, the NE frame has the same visual quality as the traditionally encoded frame, but at a lower bitrate.

The entropy codec for Gaussian splat representations can use neighbor contexts to predict the changes in position, color, size, and orientation of adjacent Gaussians. The codec performance can be tied to the accuracy of the prediction model, learning-based prediction mechanisms such as submanifold fitting with an autoencoder can be used to map the Gaussian parameters to a latent space. After obtaining predictions from the model, the prediction residuals (the difference between the predicted and actual parameter values) can be compressed using arithmetic coding or range Asymmetric Numeral Systems (rANS), being careful to preserve real-time coding performance on relevant hardware. Additional speed optimizations will include Single Instruction Multiple Data (SIMD) instructions and concurrent block-based compression.

A naive source-modeled rANS scheme can be used for 3DGS coordinates to obtain a 38+% bitrate reduction over the general-purpose DEFLATE compressor. This result reveals the potential for source-modeled compression, which existing quantization-based techniques do not capitalize on.

System 500 can be trained and evaluated on the UVG dataset of professional videos and the UGC dataset of user-generated videos. Each video can be transcoded from the datasets to a wide range of target CBR rates, and the QP decisions for each I-frame can be recorded and used as input for NE training/optimization. At every choice of QP, “excellent” P-frame reconstruction loss values of <0.05 can be targeted for the 1-“SSIM” metric, VMAF quality scores >95/100, and >20% bitrate reductions. Ubiquitous hardware-accelerated NVENC encoders 514 can be targeted for AVC, HEVC, VVC, and AV1, with fine-tuning of NE compressors 508 for each codec. NE speeds of <1 second can be obtained to compress a 4K frame at each QP level. The codecs should generalize well across different content and bitrate requirements.

Existing streaming systems waste bandwidth under stable network conditions, but novel NH encodings and adaptation algorithms can be used as disclosed herein to reduce bandwidth requirements on the MoQ streaming protocol. New representation-aware NH algorithms can be used to maximize the user QoE.

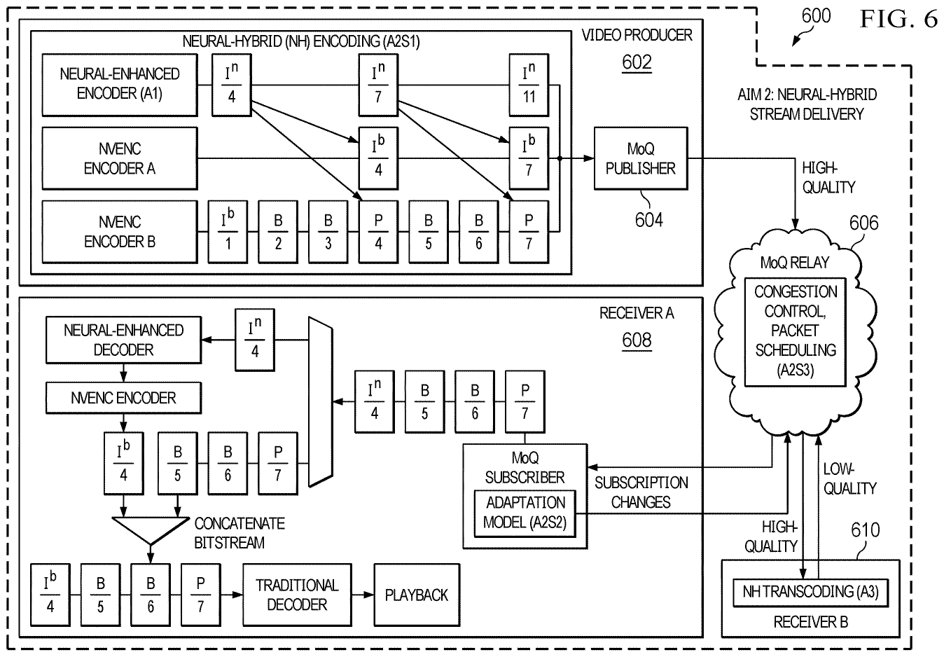

FIG. 6 is a diagram of a system 600 for an NH encoding pipeline, in accordance with an example embodiment of the present disclosure. System 600 includes video producer 602, MoQ publisher 604, MoQ relay 606, receiver A 608 and receiver B 610, each of which can be implemented in hardware or a suitable combination of hardware and software.

Video producer 602 includes NH encoding, which can use the I-frames (Iⁿ) produced by an NE image encoder as the reference to produce traditionally coded P-frames and baseline I-frames (I^{b}). Decoding Iⁿ results in the reconstructed image x′. This image data will then be provided to two traditional encoders: encoder A can be set to encode each received frame as an I-frame, while encoder B can encode it as a P-frame, referencing a previous frame in the same encoder context. Hardware-accelerated encoding can be implemented using NVIDIA GPUs from NVIDIA of Santa Clara, CA with the NVENC API or other suitable devices.

Because each Iⁿ frame can be encoded and decoded before the corresponding I^{b} and P-frames are produced, an encoder scheduling algorithm can be used for parallel processing and synchronization. The algorithm can adapt to the runtime of the NE codec. Influencing factors include input resolution, image complexity, compute capabilities, and other concurrent GPU processes such as graphics rendering. The seconds elapsed to encode the three frames at an NH index (e.g., frame 4 in system 600), T(NH), can be measured by:

$$T ( NH ) = T ( {I}_{enc}^{n} ) + T ( {I}_{dec}^{n} ) + max ( T ( {I}_{enc}^{b} ) , T ( {P}_{enc} ) ) ,$$

encompassing the encoding and decoding times for Iⁿ, followed by the maximum duration of the parallel I^{b} and P-frame encoder operations.

For a standard IBBPBBP GOP structure, T(NH)≤3G′/F seconds, where F is the source video frame rate (FPS). The constant 3 here describes the P-frame frequency in the baseline stream. G′ is a variable multiplier determining the frequency of Iⁿ and I^{b}frames. If G′=1 and F=60, then the NH time should not exceed 0.05 seconds.

The scheduler can dynamically adjust G′ based on previously measured T(NH) durations. If T(NH) exceeds the limit 3G′/F, it risks adding latency for all downstream clients. The risk can be mitigated by adding a buffer constant λ, such that T(NH)≤3G′/F+λ. If this limit is exceeded, G′ can be incremented and the NE codec can be run less frequently. Likewise, if T(NH)≤3(G′−1)/F+λ, G′ can be decremented. An appropriate A setting can be determined through experimentation on both NE codecs, various GPUs, and diverse input video resolutions and complexities.

To evaluate the potential impact of an I-frame replacement scheme, the bitrate change between small and very large GOP sizes can be analyzed. For example, the Big Buck Bunny (BBB) test video sequence can be encoded at various resolutions with x265 (for HEVC coding). Two transcoded versions can be produced at each resolution: one with a 24-frame (1-second) GOP size, and the other with an “infinite” GOP size (1 I-frame at the start). A constant quantization parameter such as qp=23 can be used to ensure identical quality. At every resolution, the infinite GOP can yield a 30-36% reduction in bitrate over a standard 1-second GOP size. Even in the absence of dedicated I-frames, intra-coding still occurs, such as intra-coded macroblocks that can be present in P- and B-frames when they yield greater compression efficiency, such as during scene changes.

I-frames can also or alternatively be injected in place of P-frames with no significant reduction in quality. The AGiLE and HESP methods use specially modified software encoders that are closed source. To verify the technique, two HEVC streams can be spliced at a frame injection point. This architecture can be integrated with the hardware-accelerated NVENC API, as software modifications or in other suitable manners.

MoQ adaptation systems can be used to balance QoE, cost, and latency. Encoded frames as disclosed herein can be sent from MoQ publisher 604 (and subsequent MoQ relays 606) to receivers, such as receiver A 608 or receiver B 610, across four MoQ Tracks, corresponding to the four frame types: Iⁿ, I^{b}, P, and B. These four tracks in tandem can constitute one NH representation. When there is a change in network congestion, the client can perform rate adaptation by unsubscribing from all Tracks in its current representation (e.g., at a high quality), then dynamically subscribing to the appropriate tracks in the new representation (e.g., at a low quality).

A client needs subscribe to only one of the Iⁿ or I^{b} tracks, dependent on its hardware support for NE decoding. If the client supports NE decoding, it can re-encode the resulting image from Iⁿ to generate an I^{b} frame. The client receives only one I-frame when switching to a new representation, greatly reducing the overall bandwidth. The I-frame can be concatenated with the received P- and B-frames to create a single video bitstream.

Traditional ABR algorithms continually estimate the connection throughput to make decisions on quality switches, seeking to maximize the QoE within a certain latency target. The present disclosure generates a highly “spiky” bandwidth when the client switches to a new quality level. That is, the first frame received will be inter-coded (Iⁿ or I^{b}) at a high data rate, while all subsequent P- and B-frames for the representation will have a much lower data rate. Therefore, even if the client begins subscribing to a lower quality level, there will be an initial spike where the data rate is higher. A learning-based ABR algorithm such as LoL+ can be used to tune the weight selection component to expect large spikes for new quality levels.

For MoQ-based streaming, adaptation algorithms can be used for event camera and point cloud data streams. MoQ can maintain extremely low (<50 ms) latency even under congestion, so long as the base quality representation is a sufficiently low bitrate.

QoE can be improved with NH-aware networking by focusing on how Tracks are transmitted over the network under congestion. Because QUIC transport is implemented in user space, it can be optimized for a particular representation and application. To this end, QUIC's congestion control algorithms and packet scheduling can be modified to have better awareness of the data that is being sent and the application-level quality goals.

Buffer scenarios can lower a user's QoE. In HTTP-based streaming, the client adaptation algorithm is responsible for avoiding buffering by requesting data at a quality below the current network bandwidth. With the disclosed MoQ-based system, the congestion control algorithm can be modified to react to buffering on the sender side. When the client experiences a buffering scenario, a custom MoQ control message can be sent to the relay to classify the event, and this information can be passed to a modified congestion control algorithm, such as BBR, to force a transition into the “congestion avoidance” state.

Packet scheduling can be improved by leveraging QUIC's stream priorities. A stream with a higher priority value means that the QUIC stack will pace that stream's packets with a higher frequency, making them more likely to be transmitted under congestion scenarios. Under MoQ, the stream priority can be set for each Track at the relay. For each representation, the Iⁿ and I^{b} Tracks can be set to have a high priority, the P-frame Track to have a moderate priority, and the B-frame Track to have a low priority. The appropriate priority levels and how best to adjust priorities when performing quality switches can then be determined.

The QUIC stream priorities can be instrumental for layered streaming. With a strict priority hierarchy, the highest-priority stream can be ensured to get the most data delivered during congestion. The use of multiple Track streams can increase the overall throughput during congestion, by allowing complementary frames to be transmitted in parallel.

In one example embodiment, the NH system can be implemented on three Linux machines. One machine can host the MoQ publisher and relay, one can host the client, and one can serve as a router. Standard Linux tools such as tc and tcpreplay can be used to simulate various network conditions and replay real-world network trace files. Under realistic simulated conditions, a bitrate switching rate <10% for high QoE and end-to-end latency <500 ms can be obtained. Adaptation and congestion control mechanisms can use NH coding to further reduce the quality switch rate and therefore improve the average received visual quality.

The MoQ relays can be deployed on cloud infrastructure (e.g., AWS EC2 instances). The MoQ publisher can be a GPU-accelerated local machine that encodes multiple quality representations simultaneously. From this deployment, the subjective QoE of the end-to-end streaming system can be measured. An improvement in the MOS of 0.5/5 under both high- and low-bandwidth scenarios when employing our NH coding, NH-aware adaptation, and congestion control modifications can be obtained. Heterogeneous devices (i.e., desktops and smartphones) can be used to evaluate the computational requirements to decode NH representations.

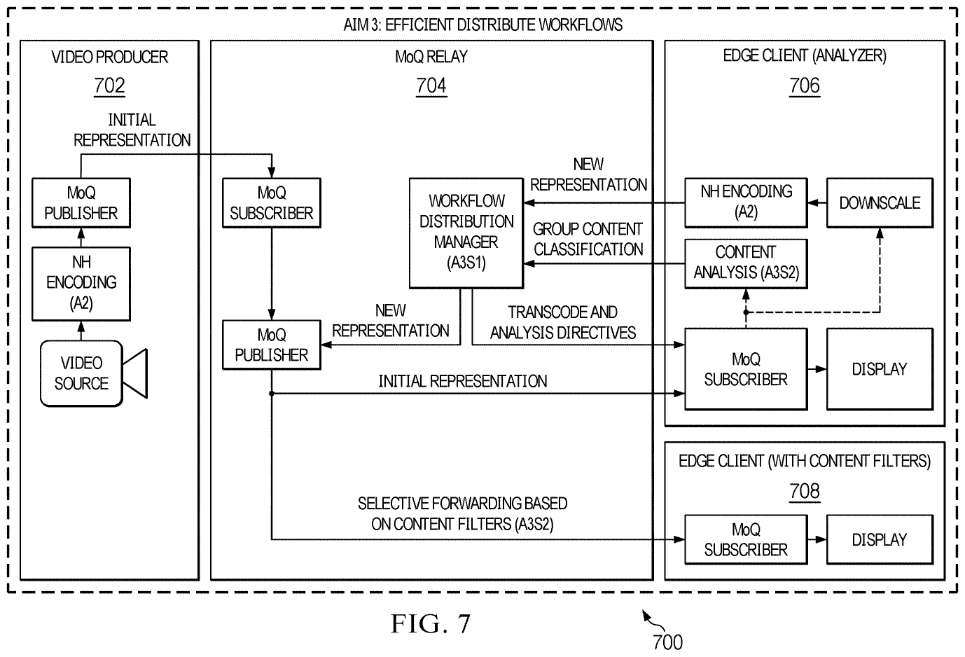

FIG. 7 is a diagram of system 700 for receiver-driven transcode, content analysis, and filtering, in accordance with an example embodiment of the present disclosure. System 700 includes video producer 702, MoQ relay 704, edge client analyzer 706 and edge client with content filters 708, each of which can be implemented in hardware or a suitable combination of hardware and software.

Server-side transcode is resource-intensive and costly. Automated live stream moderation is infeasible and too rigid. A distributed system is disclosed that delegates video transcoding and content analysis tasks to edge clients, improving processing efficiency and reliability in dynamic network environments. The system can adapt to fluctuating latency, heterogeneous device capabilities, and potential failures, maintaining high content quality and robustness during live video streaming.

Adaptive device selection and workflow distribution can be implemented using an intelligent, resource-aware distribution strategy that dynamically selects edge devices to execute video transcoding and analysis tasks in parallel, ensuring balanced load and minimal latency. A workflow manager, operating on each MoQ relay can maintain a live registry of active devices. Each device periodically reports its resource profile (computing capacity, available memory, storage, battery status) and network situation (e.g., throughput, losses) to the workflow manager. The manager first applies content complexity analysis using VCA to characterize spatial and temporal features of the video. It then uses ML-based time prediction models (e.g., an ensemble ExtraTrees regressor) to estimate the expected completion time of each frame task. The prediction incorporates task complexity (video content, bitrate, resolution, QP, frame rate, codec type), current network conditions, and each device's resource profile. Based on these predictions, the manager assigns tasks across heterogeneous edge devices, either (i) allocating separate devices for transcoding and analysis, or (ii) co-locating both tasks on the same device when this minimizes transfer latency.

The distribution strategy is guided by a reinforcement learning (RL)-based decision model that continuously adapts task assignment decisions based on observed performance feedback (e.g., completion time and network delay). The RL model learns policies that balance latency and system load across heterogeneous devices as conditions evolve. The system supports dynamic device registration and failure recovery. New devices can join at any point during a live stream, and their resource profiles are immediately integrated into the distribution process. If a device fails or disconnects, the manager automatically reassigns unfinished tasks to remaining devices with minimal disruption. Viewer devices may appear or disappear during real-time video playback.

A distributed content filtering system for MoQ-based live streaming is disclosed in which selected client devices specify their role through ANALYZE or FILTER subscription classifications. Devices subscribing with ANALYZE perform real-time inspection of a received video segment to detect potentially objectionable or unsafe content, including, photosensitive strobe epilepsy (PSE) risks, smoking, violence, or nudity. The analyzer combines a luminance change detector (for PSE risks) with Convolutional Neural Network (CNN)-based or transformer-based semantic content analysis. We will employ lightweight deep learning models such as MobileNet (for whole-image classification tasks) or Tiny YOLO (for simultaneous object classification and localization in real-time). To enable accurate detection of such categories, transfer learning can be used, initializing models with weights pre-trained on ImageNet/COCO, and fine-tuning them on content-specific datasets relevant to platform moderation needs. If the analyzer determines that the current video segment is safe, it sends an approval message to the relay. The relay then forwards only the approved video segments to viewers who subscribe with the relevant FILTER flags, while all other viewers may continue receiving the unfiltered stream without interruption.

Workflow manager algorithms can be used to ensure that analysis tasks are delegated only to devices with the necessary computational power. For increased accuracy, the same analysis task can be delegated to multiple devices, and a parity voting scheme can be used to determine a classification consensus.

An MoQ system can be used for client-side video analysis and content filtering, MoQ message parameters, a custom relay implementation, and a video “strobe” detection application written in WebAssembly. The latency penalty for a client with content filters enabled can be as little as the GOP duration (e.g., 1 second), while non-filtering clients experience no added latency. In a more complex application, 480p image classification can be performed with MobileNetV4 on a Pixel 7 Pro smartphone at a minimum rate of 8 FPS.

Heterogeneous edge devices (e.g., smartphones and desktop computers) can have a variety of compute levels. With N simultaneous workflow tasks (e.g., transcoding to a certain bitrate, analyzing strobe content), each spanning 1 second of input video, a 100% task completion rate at <1 second maximum latency with >5N subscribers in the worker pool can be provided. Analysis applications can target both precision and recall rates 90%. When simulating worker failure due to device disconnection, a task reassignment latency of <500 ms can be targeted. The workflow distribution algorithms can maintain stall-free playback for all users (except when content has been blocked), even under low-bandwidth and high worker disconnection rates.

The disclosed system reduces live stream video bandwidth usage by 10-30% with no significant impact on visual quality. Content analysis and filtering techniques increase stream safety and accessibility, such as by blocking “strobe” sequences for users with photosensitive epilepsy. The control algorithms have broader implications for QUIC congestion control on the Internet, and for distributing system workflows onto edge compute devices. By enabling adaptive, low-latency delivery of high-fidelity video, the system can improve the feasibility and video quality for remote scientific collaboration in bandwidth-constrained environments, such as field stations, mobile labs, or citizen science platforms. This capability broadens participation in data-intensive science and fosters inclusive research practices.

The disclosed systems and processes can include one or more of the stream representations encoded with a learning-based codec or Gaussian splat-based codec. The disclosed systems and processes can also include one or more of the transcoded video representation streams encoded with a learning-based codec or Gaussian splat-based codec. The disclosed systems and processes can include a server that determines which streaming clients will perform local transcoding of the one or more video representation streams. The disclosed systems and processes can also include a server that makes its determination based on one or more of the streaming clients' battery life, processing power, encoder support, decoder support, connection bandwidth, connection latency, and connection stability.

As used herein, the singular forms “a”, “an” and “the” are intended to include the plural forms as well, unless the context clearly indicates otherwise. It can be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes one or more microcomputers or other suitable data processing units, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general-purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections. The term “data” can refer to a suitable structure for using, conveying or storing data, such as a data field, a data buffer, a data message having the data value and sender/receiver address data, a control message having the data value and one or more operators that cause the receiving system or component to perform a function using the data, or other suitable hardware or software components for the electronic processing of data.

In general, a software system is a system that operates on a processor to perform predetermined functions in response to predetermined data fields. A software system is typically created as an algorithmic source code by a human programmer, and the source code algorithm is then compiled into a machine language algorithm with the source code algorithm functions, and linked to the specific input/output devices, dynamic link libraries and other specific hardware and software components of a processor, which converts the processor from a general-purpose processor into a specific purpose processor. This well-known process for implementing an algorithm using a processor should require no explanation for one of even rudimentary skill in the art. For example, a system can be defined by the function it performs and the data fields that it performs the function on. As used herein, a NAME system, where NAME is typically the name of the general function that is performed by the system, refers to a software system that is configured to operate on a processor and to perform the disclosed function on the disclosed data fields. A system can receive one or more data inputs, such as data fields, user-entered data, control data in response to a user prompt or other suitable data, and can determine an action to take based on an algorithm, such as to proceed to a next algorithmic step if data is received, to repeat a prompt if data is not received, to perform a mathematical operation on two data fields, to sort or display data fields or to perform other suitable well-known algorithmic functions. Unless a specific algorithm is disclosed, then any suitable algorithm that would be known to one of skill in the art for performing the function using the associated data fields is contemplated as falling within the scope of the disclosure. For example, a message system that generates a message that includes a sender address field, a recipient address field and a message field would encompass software operating on a processor that can obtain the sender address field, recipient address field and message field from a suitable system or device of the processor, such as a buffer device or buffer system, can assemble the sender address field, recipient address field and message field into a suitable electronic message format (such as an electronic mail message, a TCP/IP message or any other suitable message format that has a sender address field, a recipient address field and message field), and can transmit the electronic message using electronic messaging systems and devices of the processor over a communications medium, such as a network. One of ordinary skill in the art would be able to provide the specific coding for a specific application based on the foregoing disclosure, which is intended to set forth exemplary embodiments of the present disclosure, and not to provide a tutorial for someone having less than ordinary skill in the art, such as someone who is unfamiliar with programming or processors in a suitable programming language. A specific algorithm for performing a function can be provided in a flow chart form or in other suitable formats, where the data fields and associated functions can be set forth in an exemplary order of operations, where the order can be rearranged as suitable and is not intended to be limiting unless explicitly stated to be limiting.

It should be emphasized that the above-described embodiments are merely examples of possible implementations. Many variations and modifications can be made to the above-described embodiments without departing from the principles of the present disclosure. All such modifications and variations are intended to be included herein within the scope of this disclosure and protected by the following claims.

What is claimed is:

1. A system for video streaming, the system comprising:
a video encoder configured to encode a source video into at least one stream representation having a group of pictures (GOP) size, wherein the video encoder is further configured to (a) encode inter-coded P-frames using the GOP size and (b) at regular intervals within the GOP, separately generate intra-coded I-frames corresponding to a respective inter-coded frame at an index in the stream representation;
a stream packager configured to receive the stream representation from the video encoder and to produce, for each of a plurality of quality levels of the source video, at least (a) a baseline stream representation that includes I-frames and (b) a stable stream representation that includes alternate P-frame representations in place of the I-frames; and
a server configured to store the baseline stream representation and the stable stream representation and to serve segments thereof to one or more streaming clients via a network.

2. The system of claim 1 further comprising a streaming client executed on a receiver device, the streaming client configured to request a first segment from the baseline stream representation at a selected quality level to obtain an initial I-frame for decoder initialization.

3. The system of claim 2 wherein for subsequent segments following the first segment, the streaming client is configured to request segments from the stable stream representation at the selected quality level.

4. The system of claim 1 wherein the I-frames do not reset a picture order count of the stream representation.

5. The system of claim 1 further comprising a receiver configured to request segments from the stable stream representation and reduce overall bitrate with an effectively increasing GOP size.

6. The system of claim 1 further comprising a streaming client executed on a receiver device, the streaming client configured to initiate a streaming session.

7. The system of claim 1 further comprising a streaming client executed on a receiver device, the streaming client configured to initiate a streaming session and to request a first segment from the baseline stream representation at a selected quality level to obtain an initial I-frame for decoder initialization.

8. The system of claim 7 where the streaming client is configured to request segments from the stable stream representation at the selected quality level for subsequent segments following the first segment.

9. The system of claim 8 where in the streaming client is configured to monitor connection stability using an adaptive bitrate adaptation algorithm.

10. The system of claim 9 wherein the streaming client is configured to request a corresponding segment from the baseline stream representation of a new quality level to obtain a CRA I-frame for decoder re-synchronization upon determining that a quality-level switch is necessary based on the monitored connection stability.

11. A method for video streaming comprising:
encoding a source video into at least one stream representation having a group of pictures (GOP) size using a video encoder by (a) encoding inter-coded P-frames using the GOP size and (b) at regular intervals within the GOP, separately generating intra-coded I-frames corresponding to a respective inter-coded frame at an index in the stream representation;
receiving the stream representation from the video encoder at a stream packager and producing, for each of a plurality of quality levels of the source video, at least (a) a baseline stream representation that includes I-frames and (b) a stable stream representation that includes alternate P-frame representations in place of the I-frames; and
storing the baseline stream representation and the stable stream representation at a server and serving segments thereof to one or more streaming clients via a network.

12. The method of claim 11 further comprising requesting a first segment from the baseline stream representation using a streaming client executed on a receiver device, at a selected quality level to obtain an initial I-frame for decoder initialization.

13. The method of claim 12 wherein for subsequent segments following the first segment, requesting segments from the stable stream representation at the selected quality level using the streaming client.

14. The method of claim 11 wherein the I-frames do not reset a picture order count of the stream representation.

15. The method of claim 11 further requesting segments from the stable stream representation using a receiver and reducing overall bitrate with an effectively increasing GOP size.

16. The method of claim 11 further comprising initiating a streaming session using a streaming client executed on a receiver device.

17. The method of claim 11 further comprising initiating a streaming session with a streaming client executed on a receiver device and requesting a first segment from the baseline stream representation at a selected quality level to obtain an initial I-frame for decoder initialization.

18. The method of claim 17 further comprising requesting segments from the stable stream representation at the selected quality level for subsequent segments following the first segment with the streaming client.

19. The method of claim 18 further comprising monitoring connection stability using an adaptive bitrate adaptation algorithm with the streaming client.

20. The method of claim 19 further comprising requesting a corresponding segment from the baseline stream representation of a new quality level using the streaming client to obtain a CRA I-frame for decoder re-synchronization upon determining that a quality-level switch is necessary based on the monitored connection stability.

21. A system for video workflow distribution, the system comprising:
a streaming client receiving one or more video representation streams from a server;
and the streaming client performing local transcoding of the one or more video representation streams.

22. The system of claim 21 further comprising the streaming client sending one or more of the locally transcoded video representation streams to a server.

23. The system of claim 21 wherein one or more of the received video representation streams is encoded with a learning-based codec or Gaussian splat-based codec.
